(19) United States
(12) Patent Application Publication
(10) Pub. No.: US 2021/0079847 A1
(43) Pub. Date: Mar. 18, 2021

(54) FUEL NOZZLE AND COMBUSTOR FOR GAS TURBINE, AND GAS TURBINE

(71) Applicant: Mitsubishi Power, Ltd., Yokohama-shi, Kanagawa (JP)

(72) Inventors: Tomo KAWAKAMI, Yokohama-shi (JP); Satoshi TAKIGUCHI, Tokyo (JP); Naoki TSUNODA, Tokyo (JP); Mitsuhiro MORISHITA, Yokohama-shi (JP)

(21) Appl. No.: 17/050,080

(22) PCT Filed: Jun. 11, 2019
(86) PCT No.: PCT/JP2019/023056

§ 371 Date: Oct. 23, 2020

(30) Foreign Application Priority Data
Jun. 13, 2018 (JP) 2018-112383

(51) Int. Cl. F02C 7/22; F23R 3/28

(52) U.S. Cl. CPC F02C 7/22; F23R 3/286; F05D 2220/32; F05D 2240/24; F05D 2260/60; F05D 2240/12; F05D 2240/35

(57) ABSTRACT

A fuel nozzle for a gas turbine is a diffusion combustion type fuel nozzle for a gas turbine, including a nozzle body, a plurality of nozzle holes arranged along a circumferential direction of the nozzle body, each of the nozzle holes extending along an axial direction of the nozzle body and having a center axis inclined toward a center axis of the nozzle body downstream in the axial direction of the nozzle body, and a plurality of fuel supply holes extending along the axial direction of the nozzle body and connected to the plurality of nozzle holes to serve as fuel supply paths for supplying fuel, respectively. Each of the nozzle holes has an injection opening for injecting the fuel to a downstream end portion in the axial direction of the nozzle body.

### TECHNICAL FIELD

The present disclosure relates to a fuel nozzle and a combustor for a gas turbine, and the gas turbine.

### BACKGROUND

In a gas turbine fueled by a gas such as coal gasification gas, a diffusion combustion type fuel nozzle for diffusively mixing the fuel and air in a combustor to be diffusively combusted may be used.

For example, Patent Document 1 discloses, in a gas turbine combustor mainly fueled by a gasification fuel, a fuel nozzle for ejecting the fuel into a combustor liner and diffusively combusting the fuel together with combustion air.

### CITATION LIST

### Patent Literature

Patent Document 1: JP2010-506131A (translation of a PCT application)

### SUMMARY

### Technical Problem

Meanwhile, in the diffusion combustion type fuel nozzle, a cross-sectional area of a nozzle hole may desirably be increased in order to cope with an increase in fuel flow.

In a typical fuel nozzle, a plurality of nozzle holes extending in the axial direction of a nozzle body (nozzle holder) are formed in the nozzle body, and the plurality of nozzle holes are disposed to be arranged in the circumferential direction of the nozzle body. Then, each of the nozzle holes has a cross-section of a true circular shape (a cross-section orthogonal to a hole axis), and is inclined so as to be closer to the center axis of the nozzle body toward downstream in the axial direction of the nozzle hole.

In such a fuel nozzle, it is considered that if the diameter (size) of the nozzle body is increased, the diameter of each of the nozzle holes can also be increased accordingly. However, changing the diameter of the nozzle body and the inclination direction of the nozzle hole changes combustion characteristics of the combustor, which may be undesirable.

Moreover, in order not to change the combustion characteristics of the combustor, if the diameter of the nozzle hole is changed while keeping the cross-sectional shape thereof the true circular, without changing the diameter of the nozzle body and the inclination direction of the nozzle hole, an interval between the adjacent nozzle holes is decreased. As a result, it may be difficult to ensure a thickness between the adjacent nozzle holes at a downstream end portion of the fuel nozzle, in particular.

In this regard, Patent Document 1 neither specifically discloses the shape of a nozzle hole in the first place nor discloses a configuration capable of coping with the increase in fuel flow while maintaining the combustion characteristics of the combustor.

In view of the above, an object of at least one embodiment of the present invention is to provide a fuel nozzle and a combustor for a gas turbine, and the gas turbine capable of coping with the increase in fuel flow while maintaining the combustion characteristics of the combustor.

### Solution to Problem

(1) A fuel nozzle for a gas turbine according to at least one embodiment of the present invention is a diffusion combustion type fuel nozzle for a gas turbine, including a nozzle body, a plurality of nozzle holes arranged along a circumferential direction of the nozzle body, the plurality of nozzle holes each extending along an axial direction of the nozzle body and having a center axis inclined toward a center axis of the nozzle body toward downstream in the axial direction of the nozzle body, and a plurality of fuel supply holes extending along the axial direction of the nozzle body and connected to the plurality of nozzle holes to serve as fuel supply paths for supplying a fuel, respectively. Each of the plurality of nozzle holes has an injection opening for injecting the fuel to a downstream end portion in the axial direction of the nozzle body. When each of the plurality of nozzle holes is projected on a projection plane orthogonal to the center axis of the nozzle hole at a position of the center axis of the nozzle hole in the injection opening, the nozzle hole has, in the projection plane, a shape deviating radially inward of the nozzle body from an imaginary circle having an area equal to an area of the nozzle hole in the projection plane, centered on a centroid of the nozzle hole.

With the above configuration (1), the nozzle hole has, in the above-described projection plane, the shape deviating radially inward of the nozzle body from the imaginary circle having the area equal to the area of the nozzle hole in the projection plane, centered on the centroid of the nozzle hole. That is, in the downstream end portion of the nozzle body where the injection opening is positioned, since the nozzle hole has the shape whose area increases on the radially inner side of the nozzle body than the imaginary circle and whose size is smaller in the circumferential direction of the nozzle body than in the imaginary circle, it is possible to increase the flow passage area of the nozzle hole while ensuring a thickness between the adjacent nozzle holes, without significantly changing the size of the nozzle body and an inclination angle of the nozzle hole with respect to the axial direction, as compared with the conventional size and inclination angle. Thus, it is possible to cope with an increase in fuel flow while maintaining combustion characteristics in a combustor.

(2) In some embodiments, in the above configuration (1), on the projection plane, a first straight line orthogonal to a radial direction of the nozzle body that bisects the area of the nozzle hole in the radial direction of the nozzle body is positioned closer to an outer end of the nozzle hole in the radial direction than a midpoint between the outer end and an inner end of the nozzle hole in the radial direction.

With the above configuration (2), on the projection plane, since the above-described first straight line is positioned closer to the outer end of the nozzle hole in the radial direction of the nozzle body (may simply be referred to as a “radial direction” hereinafter) than the midpoint between the outer end and the inner end of the nozzle hole in the radial direction, on the projection plane, of the nozzle hole, a portion between the first straight line and the inner end has a shape which is long and narrow in the radial direction, compared to a portion between the first straight line and the outer end. Therefore, a flow passage area of the nozzle hole is increased easily while ensuring the thickness between the adjacent nozzle holes, in the downstream end portion of the nozzle body.

(3) In some embodiments, in the above configuration (1) or (2), in the projection plane, each of the plurality of nozzle holes has a shape surrounded by a first circle, a second circle having a center positioned on a radially outer side of the nozzle body than a center of the first circle, and having a larger diameter than the first circle, and two common tangents of the first circle and the second circle.

With the above configuration (3), since, in the above-described projection plane, the nozzle hole has the shape surrounded by the first circle, the second circle having the center positioned on the radially outer side of the nozzle body than the center of the first circle, and having the larger diameter than the first circle, and the two common tangents of the first circle and the second circle, it is possible to implement the above configuration (1). Thus, as described in the above configuration (1), it is possible to increase the flow passage area of the nozzle hole while ensuring the thickness between the adjacent nozzle holes, without significantly changing the size of the nozzle body and the inclination angle of the nozzle hole with respect to the axial direction, as compared with the conventional size and inclination angle. Thus, it is possible to cope with the increase in fuel flow while maintaining the combustion characteristics in the combustor.

(4) In some embodiments, in the above configuration (1) or (2), each of the plurality of nozzle holes has a contour including a first linear contour portion and a second linear contour portion, in a cross-section orthogonal to the axial direction of the nozzle body, and in the cross-section, the plurality of nozzle holes include a pair of nozzle holes adjacent to each other in the circumferential direction of the nozzle body such that the first linear contour portion of one nozzle hole of the pair of nozzle holes and the second linear contour portion of the other nozzle hole of the pair of nozzle holes are disposed adjacent to each other in the circumferential direction.

With the above configuration (4), since the linear contour portions of the pair of nozzle holes are disposed adjacent to each other in the circumferential direction, for example, as compared with a case in which arc-like portions are disposed adjacent to each other in the circumferential direction, a circumferential distance between the pair of nozzle holes is ensured easily in a relatively wide range in the radial direction. Thus, the flow passage area of the nozzle hole is increased easily while ensuring the thickness between the adjacent nozzle holes. Thus, it is possible to cope with the increase in fuel flow while maintaining the combustion characteristics in the combustor.

(5) In some embodiments, in any one of the above configurations (1) to (4), a position of the center axis of each of the plurality of nozzle holes at an upstream end of the nozzle hole and a position of the center axis at a downstream end of the nozzle hole are displaced from each other in the circumferential direction of the nozzle body.

With the above configuration (5), since the nozzle hole is disposed such that the position of the center axis of the nozzle hole is displaced between an upstream end and a downstream end of the nozzle hole, it is possible to provide a swirl component for the fuel ejected from the injection opening via the nozzle hole and as described in the above configuration (1), it is possible to increase the flow passage area of the nozzle hole while ensuring the thickness between the adjacent nozzle holes, without significantly changing the size of the nozzle body and the inclination angle of the nozzle hole with respect to the axial direction, as compared with the conventional size and inclination angle. Thus, it is possible to cope with the increase in fuel flow while maintaining the combustion characteristics in the combustor, while providing the swirl component for the fuel injected from the nozzle.

(6) In some embodiments, in any one of the above configurations (1) to (5), the fuel nozzle further includes a passage positioned on a radially outer side of the nozzle body than the plurality of nozzle holes and extending in the axial direction of the nozzle body. The passage has an air injection opening for injecting air to the downstream end portion in the axial direction of the nozzle body.

With the above configuration (6), since the passage having the air injection opening is disposed on the radially outer side of the plurality of nozzle holes, it is possible to perform combustion while diffusively mixing the fuel ejected from the plurality of nozzle holes via the injection opening and the air ejected from the above-described air injection opening, in the combustor. Thus, in such a diffusion combustion type fuel nozzle, as described in the above configuration (1), it is possible to increase the flow passage area of the nozzle hole while ensuring the thickness between the adjacent nozzle holes, without significantly changing the size of the nozzle body and the inclination angle of the nozzle hole with respect to the axial direction, as compared with the conventional size and inclination angle. Thus, it is possible to cope with the increase in fuel flow while maintaining the combustion characteristics in the combustor.

(7) In some embodiments, in any one of the above configurations (1) to (6), the fuel supply paths are configured to supply a gas fuel as the fuel to the plurality of nozzle holes, respectively.

In the above configuration (7), since the gas fuel is supplied to the diffusion combustion type fuel nozzle, it is possible to obtain stable combustion characteristics, as compared with a case where a premixed combustion type nozzle is adopted which easily causes backfire or the like when a gas fuel containing much hydrogen, such as a coal gasification fuel, is used.

Thus, with the above configuration (7), it is possible to cope with the increase in fuel flow by increasing the flow passage area of the nozzle hole, while maintaining the combustion characteristics in the combustor, in the combustor using the gas fuel.

(8) In some embodiments, in any one of the above configurations (1) to (7), the fuel nozzle further includes a liquid fuel nozzle extending along the center axis of the nozzle body. The plurality of nozzle holes are positioned radially outside the liquid fuel nozzle.

With the above configuration (8), since the liquid fuel nozzle positioned radially inner side of the above-described plurality of nozzle holes is provided, it is possible to eject a plurality of kinds of fuels by using the plurality of nozzle holes and the liquid fuel nozzle. Thus, it is possible to operate the gas turbine more flexibly by using the plurality of kinds of fuels and as described in the above configuration (1), it is possible to cope with the increase in fuel flow while maintaining the combustion characteristics in the combustor.

(9) A combustor for a gas turbine according to at least one embodiment of the present invention includes the fuel nozzle according to any one of the above configurations (1) to (8), and a combustion tube forming a passage for a combustion gas generated by combustion of a fuel injected from the fuel nozzle.

With the above configuration (9), the nozzle hole has, in the above-described projection plane, the shape deviating radially inward of the nozzle body from the imaginary circle having the area equal to the area of the nozzle hole in the projection plane, centered on the centroid of the nozzle hole. That is, in the downstream end portion of the nozzle body where the injection opening is positioned, since the nozzle hole has the shape whose area increases on the radially inner side of the nozzle body than the imaginary circle and whose size is smaller in the circumferential direction of the nozzle body than in the imaginary circle, it is possible to increase the flow passage area of the nozzle hole while ensuring the thickness between the adjacent nozzle holes, without significantly changing the size of the nozzle body and the inclination angle of the nozzle hole with respect to the axial direction, as compared with the conventional size and inclination angle. Thus, it is possible to cope with the increase in fuel flow while maintaining the combustion characteristics in the combustor.

(10) A gas turbine according to at least one embodiment of the present invention includes the combustor according to the above configuration (9), and a stator vane and a rotor blade disposed downstream of the combustion tube for the combustor.

With the above configuration (10), the nozzle hole has, in the above-described projection plane, the shape deviating radially inward of the nozzle body from the imaginary circle having the area equal to the area of the nozzle hole in the projection plane, centered on the centroid of the nozzle hole. That is, in the downstream end portion of the nozzle body where the injection opening is positioned, since the nozzle hole has the shape whose area increases on the radially inner side of the nozzle body than the imaginary circle and whose size is smaller in the circumferential direction of the nozzle body than in the imaginary circle, it is possible to increase the flow passage area of the nozzle hole while ensuring the thickness between the adjacent nozzle holes, without significantly changing the size of the nozzle body and the inclination angle of the nozzle hole with respect to the axial direction, as compared with the conventional size and inclination angle. Thus, it is possible to cope with the increase in fuel flow while maintaining the combustion characteristics in the combustor.

### Advantageous Effects

According to at least one embodiment of the present invention, a fuel nozzle and a combustor for a gas turbine, and the gas turbine capable of coping with an increase in fuel flow while maintaining combustion characteristics of the combustor are provided.

### BRIEF DESCRIPTION OF DRAWINGS

FIG. 1 is a schematic configuration view of a gas turbine according to an embodiment.

FIG. 2 is a schematic cross-sectional view of a fuel nozzle according to an embodiment.

FIG. 3A is a side view of a nozzle holder of the fuel nozzle according to an embodiment.

FIG. 3B is a view of the nozzle holder shown in FIG. 3A, viewed from upstream.

FIG. 3C is a view of the nozzle holder shown in FIG. 3A, viewed from downstream.

FIG. 4A is a side view of the nozzle holder of the fuel nozzle according to an embodiment.

FIG. 4B is a view of the nozzle holder shown in FIG. 4A, viewed from upstream.

FIG. 4C is a view of the nozzle holder shown in FIG. 4A, viewed from downstream.

FIG. 5 is a view showing the shape of a nozzle hole according to an embodiment projected on a projection plane.

FIG. 6 is a view showing the shape of the nozzle hole according to an embodiment projected on the projection plane.

FIG. 7 is a view showing the shape of the nozzle hole according to an embodiment projected on the projection plane.

FIG. 8 is a cross-sectional view orthogonal to the axial direction of a nozzle body according to an embodiment.

### DETAILED DESCRIPTION

Some embodiments of the present invention will be described below with reference to the accompanying drawings. It is intended, however, that unless particularly identified, dimensions, materials, shapes, relative positions and the like of components described in the embodiments or shown in the drawings shall be interpreted as illustrative only and not intended to limit the scope of the present invention.

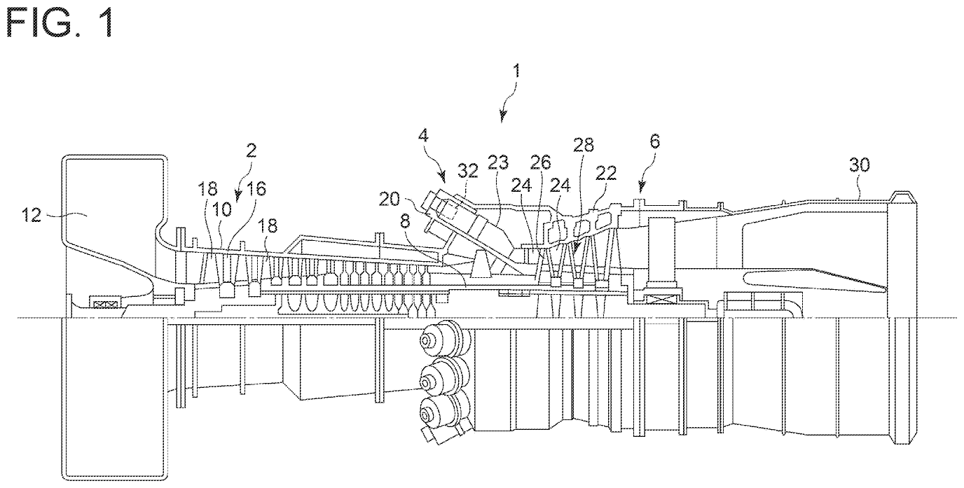

First, a gas turbine, which is an example of application of a fuel nozzle and a combustor according to some embodiments, will be described with reference to FIG. 1. FIG. 1 is a schematic configuration view of a gas turbine according to an embodiment.

As shown in FIG. 1, a gas turbine 1 includes a compressor 2 for generating compressed air, combustor s4 for each generating a combustion gas from the compressed air and fuel, and a turbine 6 configured to be rotationally driven by the combustion gas. In the case of the gas turbine 1 for power generation, a generator (not shown) is connected to the turbine 6 via a rotor 8.

The compressor 2 includes a plurality of stator vanes 16 fixed to the side of a compressor casing 10 and a plurality of rotor blades 18 implanted on the rotor 8 so as to be arranged alternately with respect to the stator vanes 16.

Intake air from an air inlet 12 is sent to the compressor 2, and passes through the plurality of stator vanes 16 and the plurality of rotor blades 18 to be compressed, turning into compressed air having a high temperature and a high pressure.

The combustors 4 are supplied with fuel and the compressed air generated in the compressor 2. The combustors 4 combust the fuel to produce a combustion gas that serves as a working fluid of the turbine 6. As shown in FIG. 1, the gas turbine 1 includes the plurality of combustors 4 which are arranged in a casing 20 along the circumferential direction centering around the rotor 8.

The turbine 6 includes a combustion gas passage 28 formed by a turbine casing 22, and includes a plurality of stator vanes 24 and rotor blades 26 disposed in the combustion gas passage 28.

Each of the stator vanes 24 is fixed to the side of the turbine casing 22. The plurality of stator vanes 24 arranged along the circumferential direction of the rotor 8 form stator vane rows. Moreover, each of the rotor blades 26 is implanted on the rotor 8. The plurality of rotor blades 26 arranged along the circumferential direction of the rotor 8 form rotor blade rows. The stator vane rows and the rotor blade rows are alternately arranged in the axial direction of the rotor 8.

In the turbine 6, the combustion gas flowing into the combustion gas passage 28 from the combustors 4 passes through the plurality of stator vanes 24 and the plurality of rotor blades 26, thereby rotationally driving the rotor 8. Consequently, the generator connected to the rotor 8 is driven to generate power. The combustion gas having driven the turbine 6 is discharged outside via an exhaust chamber 30.

Each of the combustors 4 includes a fuel nozzle 32 for injecting a fuel, and a combustion tube 23 forming a passage for the combustion gas generated by combustion of the fuel injected from the fuel nozzle 32. The stator vanes 24 and rotor blades 26 for the turbine 6 described above are positioned downstream of the combustion tube 23. The combustion gas from the combustion tube 23 flows into the combustion gas passage 28 where the stator vanes 24 and the rotor blades 26 are disposed.

The fuel nozzle 32 for the combustor 4 according to some embodiments will be described below in more detail.

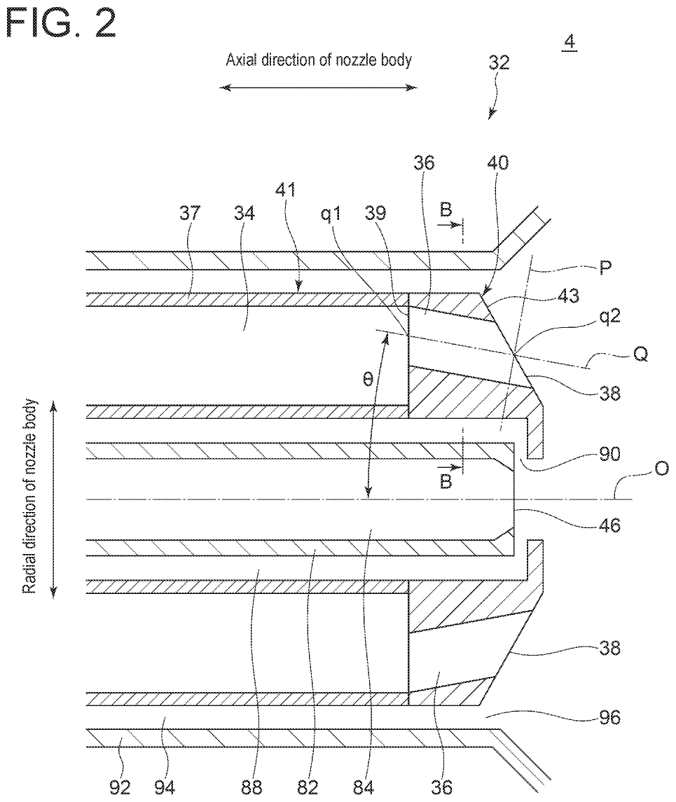

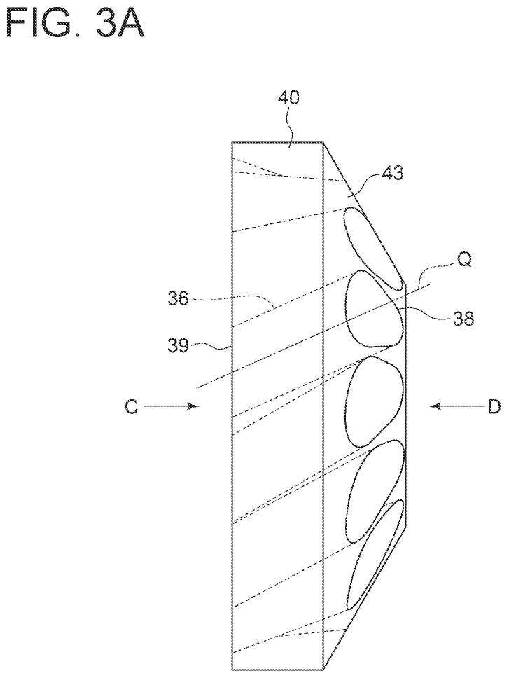

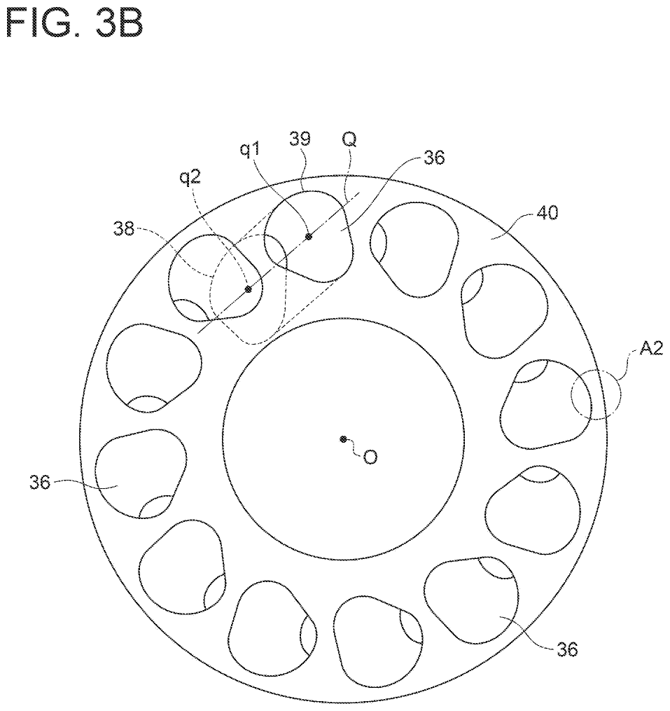

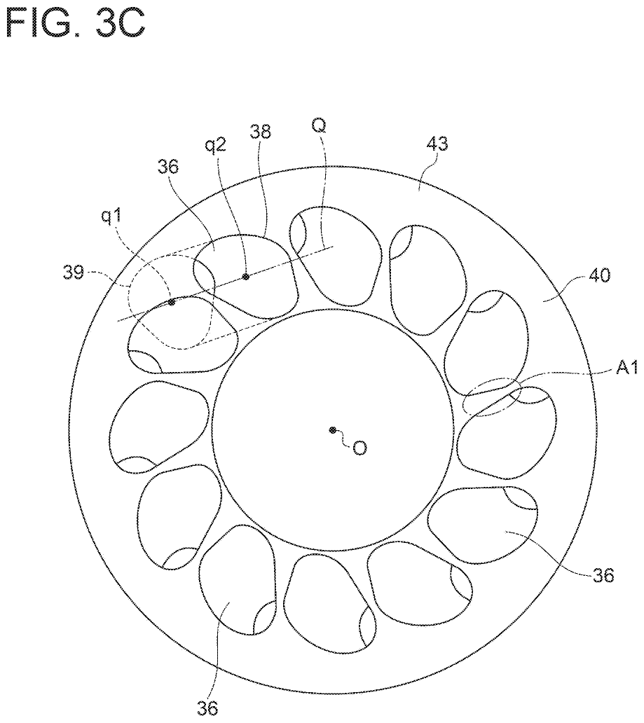

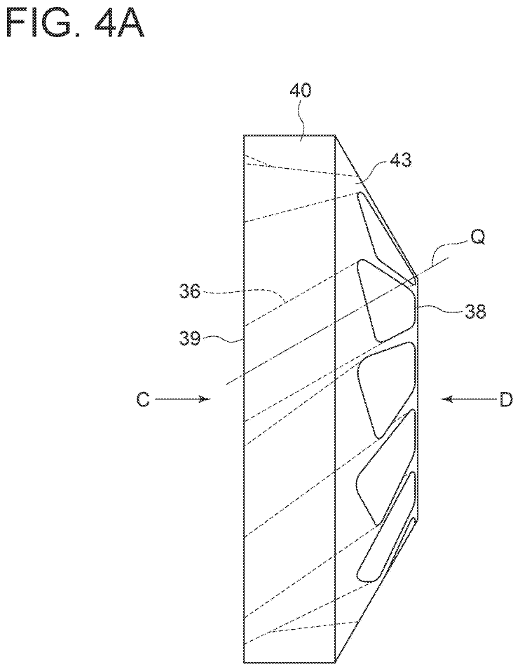

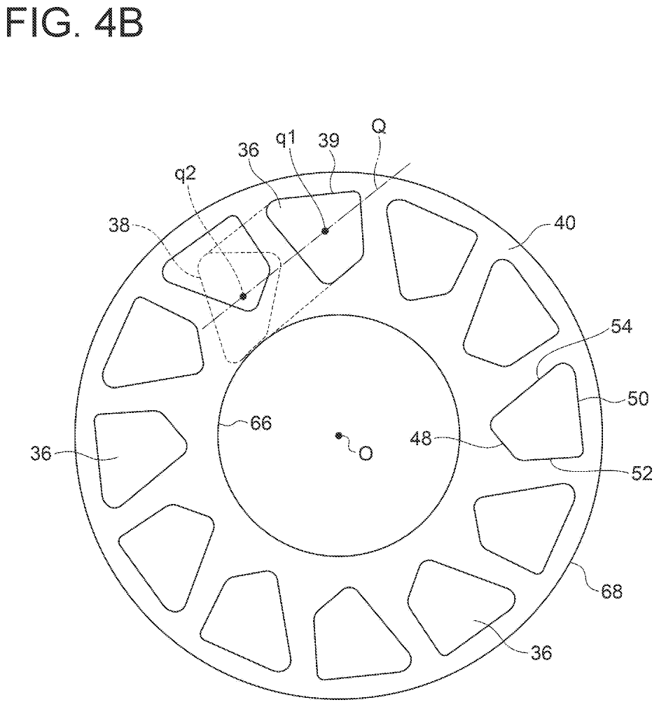

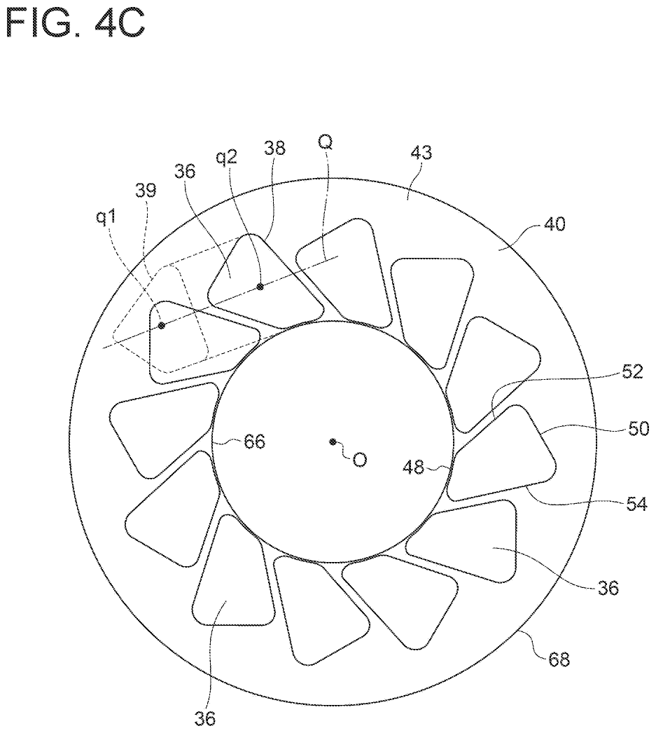

FIG. 2 is a schematic cross-sectional view of the fuel nozzle 32 according to an embodiment. Each of FIGS. 3A to 4C is a view showing a nozzle holder 40 which is a part of a nozzle body 41 of the fuel nozzle 32 according to an embodiment.

Each of FIGS. 3A and 4A is a side view of the nozzle holder 40 of the fuel nozzle 32 according to an embodiment. FIG. 3B is a view of the nozzle holder 40 shown in FIG. 3A, viewed from upstream (that is, from a C direction shown in FIG. 3A). FIG. 3C is a view of the nozzle holder 40 shown in FIG. 3A, viewed from downstream (that is, from a D direction shown in FIG. 3A). Moreover, FIG. 4B is a view of the nozzle holder 40 shown in FIG. 4A, viewed from upstream (that is, from a C direction shown in FIG. 4A). FIG. 4C is a view of the nozzle holder 40 shown in FIG. 4A, viewed from downstream (that is, from a D direction shown in FIG. 4A).

The embodiment shown in FIGS. 3A to 3C and the embodiment shown in FIGS. 4A to 4C have the same configuration, except that the cross-sectional shape of nozzle holes 36 is different. Thus, in the following description, common parts of these embodiments will be described with reference to FIGS. 3A to 3C.

As shown in FIG. 2, the fuel nozzle 32 according to an embodiment includes the nozzle body 41 and the plurality of nozzle holes 36 formed in the nozzle body 41.

The nozzle body 41 includes the nozzle holder 40 positioned most downstream in the axial direction of the nozzle body 41 (a direction of a center axis O of the nozzle body 41; may simply be referred to as the “axial direction” hereinafter), and a fuel passage forming part 37 positioned upstream of the nozzle holder 40.

As shown in FIGS. 2 and 3A to 3C, in the nozzle holder 40, the plurality of nozzle holes 36 extending along the axial direction are formed. The plurality of nozzle holes 36 are arranged along the circumferential direction of the nozzle body 41. Each of the nozzle holes 36 has an injection opening 38 for injecting a fuel to a downstream end portion in the axial direction.

In the exemplary embodiments shown in FIGS. 2 and 3A to 3C, the nozzle holder 40 has a tapered surface 43, which gets close to the center axis O of the nozzle body 41 toward downstream, at the downstream end portion in the axial direction. Each injection opening 38 of the plurality of nozzle holes 36 is formed in the above-described tapered surface 43.

In some embodiments, each of the nozzle holes 36 projected on a cross-section of the nozzle hole 36 extending linearly in the direction of a center axis Q of the nozzle hole 36 and orthogonal to the center axis Q, and a projection plane (for example, a projection plane P shown in FIG. 2) orthogonal to the center axis Q has a contour of the same shape, regardless of a position in the direction of the center axis Q. A cross-sectional shape of the nozzle hole 36 orthogonal to the direction of the center axis Q is different from a true circular, details of which are to be described later. The center axis Q may be a straight line connecting the centroid of the cross-sectional shape of the nozzle hole 36 or the shape of the nozzle hole 36 projected on the above-described projection plane.

In the fuel passage forming part 37, a fuel supply hole 34 (fuel supply path) extending along the axial direction is formed. A downstream end of the fuel supply hole 34 is connected to an upstream end 39 of the nozzle hole 36.

A fuel is supplied to the fuel supply hole 34 via a fuel supply source (not shown). The fuel is supplied from the fuel supply hole 34 to the nozzle hole 36 via a connection between the fuel supply hole 34 and the nozzle hole 36.

In some embodiments, the plurality of fuel supply holes 34 may be formed in the fuel passage forming part 37, and the downstream ends of the plurality of fuel supply holes 34 may be connected to the upstream ends 39 of the plurality of nozzle holes 36, respectively. Alternatively, in some embodiments, one annular fuel supply hole 34 may be formed in the fuel passage forming part 37, and the downstream end of the annular fuel supply hole 34 may be connected to the respective upstream ends 39 of the plurality of nozzle holes 36.

In some embodiments, a gas fuel is supplied to the fuel supply hole 34. The gas fuel may be a syngas containing, for example, CO and/or H₂, which is obtained by treating coal, biomass, or the like in a gasification furnace.

An air passage forming part 92 extending in the axial direction of the nozzle body 41 is disposed radially outside the nozzle body 41. Then, an air passage 94 (passage) extending in the axial direction is formed by the inner circumferential surface of the air passage forming part 92. The compressed air flowing in from the compressor 2 to a casing (not shown) of the combustor 4 is supplied to the air passage 94, for example. Moreover, the air passage 94 has an air injection opening 96 for injecting air to the downstream end portion in the axial direction.

As shown in FIG. 2, the air passage 94 may be formed between the outer circumferential surface of the nozzle body 41 and the inner circumferential surface of the air passage forming part 92.

The air passage 94 may be an annular passage positioned radially outside the plurality of nozzle holes 36.

A liquid fuel nozzle 82 extending along the center axis O of the nozzle body 41 is disposed radially inside the nozzle body 41. That is, the plurality of nozzle holes 36 are positioned radially outside the liquid fuel nozzle 82.

In the liquid fuel nozzle 82, a liquid fuel passage 84 is formed along the axial direction. The liquid fuel passage 84 includes a liquid fuel injection opening 46 for injecting a liquid fuel to the downstream end in the axial direction. The liquid fuel is supplied to the liquid fuel nozzle 82 from a liquid fuel supply source (not shown).

The liquid fuel injected by the liquid fuel nozzle 82 may be a fuel for starting the gas turbine 1.

In the exemplary embodiment shown in FIG. 2, an air passage 88 is disposed radially outside the liquid fuel nozzle 82 and radially inside the nozzle body 41. The compressed air flowing in from the compressor 2 to the casing (not shown) of the combustor 4 is supplied to the air passage 88, for example. The supplied air is injected from an air injection opening 90 formed at a downstream end of the air passage 88.

As shown in FIGS. 2 and 3A, each center axis Q of the plurality of nozzle holes 36 formed in the nozzle holder 40 of the nozzle body 41 is inclined toward the center axis O of the nozzle body 41, toward the downstream side in the axial direction of the nozzle body 41.

In FIG. 2, an inclination angle of the center axis Q of the nozzle hole 36 with respect to the center axis O of the nozzle body 41 is denoted by θ.

Moreover, in some embodiments, as shown in FIGS. 2, 3B, and 3C, regarding each of the plurality of nozzle holes 36, a position q1 of the center axis Q at the upstream end of the nozzle hole 36 and a position q2 of the center axis Q at the downstream end of the nozzle hole 36 are displaced from each other in the circumferential direction of the nozzle body 41. That is, each of the nozzle holes 36 is inclined in the circumferential direction of the nozzle body 41. Since the nozzle body 41 is thus inclined in the circumferential direction, a swirl component is applied to the fuel injected from the nozzle hole 36. Thus, it is possible to facilitate mixing of the fuel injected from the nozzle hole 36 and the air injected from the air passage 94 and the like.

In each of the combustors 4 which includes the fuel nozzle 32 having the above configuration, the fuel injected from the fuel nozzle 32 via the injection openings 38, and the air injected from the air passage 94 via the air injection opening 96 and/or the air injected from the air passage 88 via the air injection opening 90 are diffusively combusted while being mixed downstream of the fuel nozzle 32.

At the start of the gas turbine 1, the air (for example, the compressed air flowing in from the compressor 2 to the casing (not shown) of the combustor 4) may be supplied to the fuel supply hole 34, and the air may be supplied from the fuel supply hole 34 to the nozzle hole 36.

That is, at the start of the gas turbine 1, in each of the combustors 4, combustion may be performed while mixing the air injected from the nozzle hole 36 via the injection opening 38 and the liquid fuel injected from the liquid fuel nozzle 82, downstream of the fuel nozzle 32.

By contrast, during a normal operation (such as during a rated operation) of the gas turbine 1, the fuel is supplied to the fuel supply hole 34 as described above, and diffusion combustion may be performed while mixing the fuel injected from the nozzle hole 36 and the air injected from the air passage 94 and/or the air passage 88, downstream of the fuel nozzle 32. At this time, the injection of the liquid fuel from the liquid fuel nozzle 82 may be stopped.

In some embodiments, for example, during the normal operation of the gas turbine 1, only a fuel without inclusion of air is injected from the nozzle holes 36 via the respective injection openings 38.

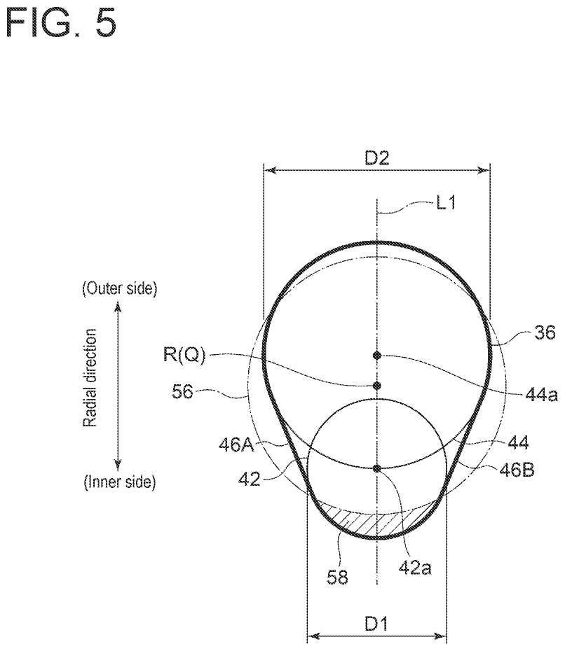

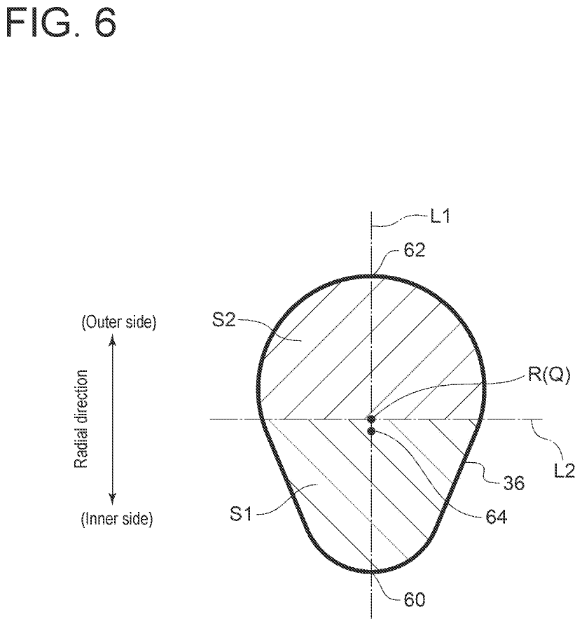

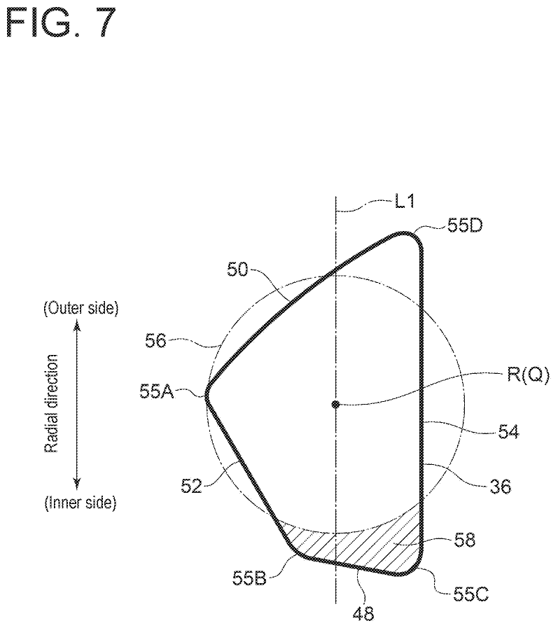

Each of FIGS. 5 to 7 is a view showing the shape of the nozzle hole 36 projected on the projection plane P (see FIG. 2). Of these drawings, FIGS. 5 and 6 each show the shape of the nozzle hole 36 according to the embodiment shown in FIGS. 3A to 3C, and FIG. 7 shows the shape of the nozzle hole 36 according to the embodiment shown in FIGS. 4A to 4C. The above-described projection plane P is a projection plane orthogonal to the center axis Q of the nozzle hole 36 at the position of the center axis Q of the nozzle hole 36 in the injection opening 38 of the nozzle hole 36.

That is, the shape of the nozzle hole 36 in the projection plane P represents the shape of the nozzle hole 36 in the downstream end portion.

In each of FIGS. 5 to 7, a straight line L1 indicates a straight line in the radial direction of the nozzle body 41.

As shown in FIG. 5, the nozzle hole 36 according to the embodiment shown in FIGS. 3A to 3C has a shape surrounded by a first circle 42 with a diameter D1, a second circle 44 with a diameter D2, and two common tangents 46A, 46B of the first circle 42 and the second circle 44, in the projection plane P. The second circle 44 has a center 44a which is positioned on the radially outer side of the nozzle body 41 than a center 42a of the first circle 42. The diameter D2 of the second circle 44 is larger than the diameter D1 of the first circle 42.

In FIG. 5, a straight line connecting the center 42a of the first circle 42 and the center 44a of the second circle 44 is the same as L1, and match the radial direction of the nozzle body 41. However, the straight line connecting the center 42a of the first circle 42 and the center 44a of the second circle 44, and the radial direction of the nozzle body 41 may not match. For example, an angle formed by the above straight line and the radial direction of the nozzle body 41 may be not more than 30 degrees.

Moreover, as shown in FIG. 7, regarding each of the nozzle holes 36 according to the embodiment shown in FIGS. 4A to 4C, the contour of the nozzle hole 36 has a shape similar to a rectangle including a first linear contour portion 52, a second linear contour portion 54, a third linear contour portion 48, and a fourth linear contour portion 50, all of which are linear portions, in the projection plane P. Those linear contour portions 48 to 54 are connected by connections 55A to 55D positioned at corners of the above-described rectangle, respectively.

In the above-described rectangle, the first linear contour portion 52 and the second linear contour portion 54 are positioned so as to face each other, and the third linear contour portion 48 and the fourth linear contour portion 50 are positioned so as to face each other.

Note that the each of the linear contour portions 48 to 54 may not be a complete straight line and may have a curved shape having a relatively small curvature.

In some embodiments, the contour of the nozzle hole 36 in the projection plane P may have another shape and may have, for example, a polygonal shape such as a triangle or a pentagon, as a whole.

In some embodiments, for example, as shown in FIGS. 5 and 7, when the nozzle hole 36 is projected on the above-described projection plane P, the nozzle hole 36 has, in the projection plane P, a shape which includes a portion 58 (a shaded portion in each of FIGS. 5 and 7) deviating radially inward of the nozzle body 41 from an imaginary circle 56 having an area equal to an area of the nozzle hole 36 in the projection plane P, centered on a centroid (gravity center) R of the nozzle hole 36.

Forming the shape of the nozzle hole 36 in the downstream end portion as described above, it is possible to cope with an increase in fuel flow while maintaining the combustion characteristics in the combustor 4, for the following reasons.

That is, in the fuel nozzle, if the flow passage area is to be increased while suppressing a change in combustion characteristics, the flow passage area needs to be increased without changing the size of the nozzle holder (nozzle body) where the nozzle hole is formed, as well as without changing the inclination angle of the nozzle hole in the axial direction and the circumferential direction of the nozzle body.

For example, regarding the conventional typical diffusion combustion type fuel nozzle (that is, the fuel nozzle configured such that the nozzle hole has a true circular cross-sectional shape, and the center axis of the nozzle hole is oblique to the center axis of the nozzle body), if the flow passage area (that is, a hole diameter) is to be increased without changing the size of the nozzle body and the inclination angle of the nozzle hole, the interval between the adjacent nozzle holes is decreased, which may particularly make it difficult to ensure a thickness between the adjacent nozzle holes (see a portion A1 in FIG. 3C) in the downstream end portion of the nozzle holder. Moreover, in the upstream end portion of the nozzle holder, it may be difficult to ensure a thickness between the nozzle hole and the outer circumferential edge of the nozzle holder (see a portion A2 in FIG. 3B).

In this regard, according to the above-described embodiments, the nozzle hole 36 has, in the above-described projection plane P, the shape which includes the portion 58 deviating radially inward of the nozzle body 41 from the imaginary circle 56 having the area equal to the area of the nozzle hole 36 in the projection plane P, centered on the centroid R of the nozzle hole 36. That is, in the downstream end portion of the nozzle body 41 where the injection opening 38 is positioned, since the nozzle hole 36 has the shape whose area increases on the radially inner side of the nozzle body 41 than the imaginary circle 56 and whose size is smaller in the circumferential direction of the nozzle body 41 than in the imaginary circle 56, it is possible to increase the flow passage area of each of the nozzle holes 36 while ensuring the thickness between the adjacent nozzle holes 36 and the thickness between the nozzle hole 36 and the outer circumferential edge of the nozzle holder 40 (nozzle body 41), without significantly changing the diameter (size) of the nozzle body 41 and the inclination angle θ (see FIG. 2) of the nozzle hole 36 with respect to the axial direction, as compared with the conventional diameter and inclination angle. Thus, it is possible to cope with the increase in fuel flow while maintaining the combustion characteristics in the combustor 4.

In some embodiments, for example, as shown in FIG. 6, a first straight line L2 orthogonal to the radial direction (the direction of the straight line L1) of the nozzle body 41 that bisects an area (S1+S2) of the nozzle hole 36 is positioned closer to an outer end 62 of the nozzle hole 36 in the radial direction than a midpoint 64 between the outer end 62 and an inner end 60 of the nozzle hole 36 in the radial direction, on the projection plane P. That is, a distance between the outer end 62 and the first straight line L2 is shorter than a distance between the inner end 60 and the first straight line L2.

In an example shown in FIG. 6, of the nozzle hole 36, an area S1 of a portion on the radially inner side of the first straight line L2 and an area S2 of a portion on the radially outer side of the first straight line L2 are equal to each other. Moreover, in the projection plane P, the centroid R of the nozzle hole 36 is positioned on the first straight line L2.

In the above-described embodiments, on the projection plane P, since the first straight line L2 is positioned closer to the outer end 62 of the nozzle hole 36 in the radial direction of the nozzle body 41 than the midpoint 64 between the outer end 62 and the inner end 60 of the nozzle hole 36 in the radial direction, of the nozzle hole 36, the portion between the first straight line L2 and the inner end 60 (the portion of the area S1) has a shape which is long and narrow in the radial direction, compared to the portion between the first straight line L2 and the outer end 62 (the portion of the area S2). Therefore, the flow passage area of each of the nozzle holes 36 is increased easily while ensuring the thickness between the adjacent nozzle holes 36, in the downstream end portion of the nozzle body 41.

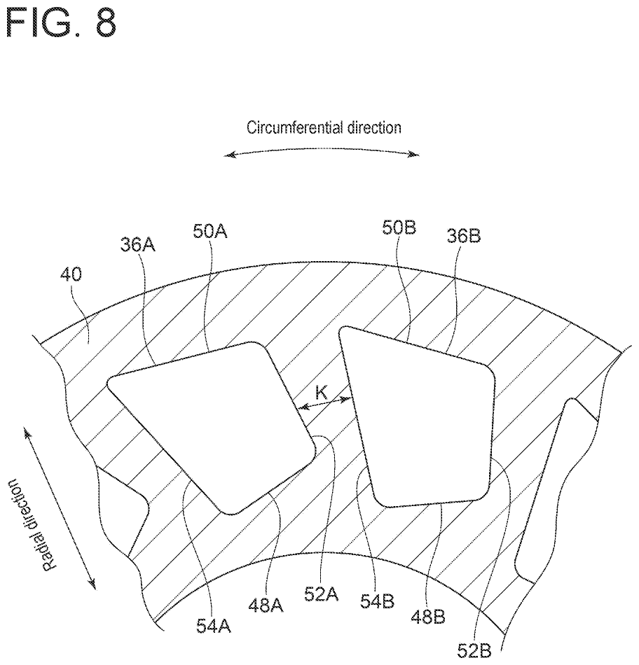

FIG. 8 is a cross-sectional view orthogonal to the axial direction of the nozzle body 41 according to an embodiment and is a view corresponding to the cross-section taken along line B-B of FIG. 2. FIG. 8 shows the cross-section of the nozzle body 41 having the nozzle holes 36 according to the embodiment shown in FIGS. 4A to 4C.

FIG. 8 shows a pair of nozzle holes 36A, 36B adjacent to each other in the circumferential direction. The contours of the nozzle holes 36A, 36B shown in FIG. 8 respectively have shapes similar to the rectangles including first linear contour portions 52A, 52B, second linear contour portions 54A, 54B, third linear contour portions 48A, 48B, and fourth linear contour portions 50A, 50B, all of which are linear portions. These first to fourth linear contour portions correspond to the first to fourth linear contour portions in FIG. 7, respectively.

In some embodiments, for example, as shown in FIG. 8, in the above-described cross-section, of the pair of nozzle holes 36A, 36B adjacent to each other in the circumferential direction, the first linear contour portion 52A of the one nozzle hole 36A and the second linear contour portion 54B of the other nozzle hole 36B are disposed adjacent to each other in the circumferential direction.

In this case, since the linear contour portions of the pair of nozzle holes 36A, 36B are disposed adjacent to each other in the circumferential direction, for example, as compared with a case in which arc-like portions are disposed adjacent to each other in the circumferential direction, a circumferential distance K (see FIG. 8) between the pair of nozzle holes 36A, 36B is ensured easily in a relatively wide range in the radial direction. Thus, the flow passage area of each of the nozzle holes 36 is increased easily while ensuring a thickness between the adjacent nozzle holes 36A, 36B. Thus, it is possible to cope with the increase in fuel flow while maintaining the combustion characteristics in the combustor 4.

In the above-described cross-section, of the pair of nozzle holes 36A, 36B adjacent to each other in the circumferential direction, the first linear contour portion 52A of the one nozzle hole 36A and the second linear contour portion 54B of the other nozzle hole 36B may form an angle (see FIG. 8) of, for example, not more than 25 degrees.

In this case, it is easy to ensure the circumferential distance K (see FIG. 8) between the pair of nozzle holes 36A, 36B more reliably in the relatively wide range in the radial direction. Thus, the flow passage area of each of the nozzle holes 36 is increased more easily while ensuring the thickness between the adjacent nozzle holes 36A, 36B.

In the exemplary embodiment shown in FIGS. 4A to 4C, for example, as shown in FIG. 4C, the nozzle hole 36 may include a linear contour portion (the illustrated third linear contour portion 48) extending along an inner circumferential edge 66 of the nozzle holder 40 (nozzle body 41), at the downstream end of the nozzle hole 36 (the injection opening 38; or the downstream end of the nozzle holder 40).

Thus including the linear contour portion extending along the inner circumferential edge 66 of the nozzle body 41, it is possible to form the nozzle hole 36 into a shape where the flow passage area is significantly increased radially inward, on the downstream end side of the nozzle hole 36. Thus, it is possible to increase the flow passage area of each of the nozzle holes 36 more effectively.

Moreover, in the exemplary embodiment shown in FIGS. 4A to 4C, for example, as shown in FIG. 4B, the nozzle hole 36 may include a linear contour portion (the illustrated fourth linear contour portion 50) extending along an outer circumferential edge 68 of the nozzle holder 40 (nozzle body 41), at the upstream end 39 of the nozzle hole 36 (or the upstream end of the nozzle holder 40).

Thus including the linear contour portion extending along the outer circumferential edge 68 of the nozzle body 41, it is possible to form the nozzle hole 36 into a shape where the flow passage area is significantly increased radially outward, on the upstream end side of the nozzle hole 36. Thus, it is possible to increase the flow passage area of each of the nozzle holes 36 more effectively.

Embodiments of the present invention were described in detail above, but the present invention is not limited thereto, and also includes an embodiment obtained by modifying the above-described embodiments and an embodiment obtained by combining these embodiments as appropriate.

Further, in the present specification, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, an expression of a shape such as a rectangular shape or a cylindrical shape shall not be construed as only the geometrically strict shape, but also includes a shape with unevenness or chamfered corners within the range in which the same effect can be achieved.

As used herein, the expressions “comprising”, “containing” or “having” one constitutional element is not an exclusive expression that excludes the presence of other constitutional elements.

### REFERENCE SIGNS LIST

1 Gas turbine
2 Compressor
4 Combustor
6 Turbine
8 Rotor
10 Compressor casing
12 Air inlet
16 Stator vane
18 Rotor blade
20 Casing
22 Turbine casing
23 Combustion tube
24 Stator vane
26 Rotor blade
28 Combustion gas passage
30 Exhaust chamber
32 Fuel nozzle
34 Fuel supply hole
36 Nozzle hole
37 Fuel passage forming part
38 Injection opening
39 Upstream end
40 Nozzle holder
41 Nozzle body
42 First circle
42a Center
43 Tapered surface
44 Second circle
44a Center
46 Liquid fuel injection opening
46A, 46B Common tangent
48 Third linear contour portion
50 Fourth linear contour portion
52 First linear contour portion
54 Second linear contour portion
55A to 55D Connection
56 Imaginary circle
58 Portion
60 Inner end
62 Outer end
64 Midpoint
66 Inner circumferential edge
68 Outer circumferential edge
82 Liquid fuel nozzle
84 Liquid fuel passage
88 Air passage
90 Air injection opening
92 Air passage forming part
94 Air passage
96 Air injection opening
L2 First straight line
O Center axis
P Projection plane
Q Center axis
R Centroid (gravity center)

1. A diffusion combustion type fuel nozzle for a gas turbine, comprising:
a nozzle body;
a plurality of nozzle holes arranged along a circumferential direction of the nozzle body, the plurality of nozzle holes each extending along an axial direction of the nozzle body and having a center axis inclined toward a center axis of the nozzle body toward downstream in the axial direction of the nozzle body; and
a plurality of fuel supply holes extending along the axial direction of the nozzle body and connected to the plurality of nozzle holes to serve as fuel supply paths for supplying a fuel, respectively,
wherein each of the plurality of nozzle holes has an injection opening for injecting the fuel to a downstream end portion in the axial direction of the nozzle body, and
wherein, when each of the plurality of nozzle holes is projected on a projection plane orthogonal to the center axis of the nozzle hole at a position of the center axis of the nozzle hole in the injection opening, the nozzle hole has, in the projection plane, a shape deviating radially inward of the nozzle body from an imaginary circle having an area equal to an area of the nozzle hole in the projection plane, centered on a centroid of the nozzle hole.

2. The fuel nozzle for the gas turbine according to claim 1,
wherein, on the projection plane, a first straight line orthogonal to a radial direction of the nozzle body that bisects the area of the nozzle hole in the radial direction of the nozzle body is positioned closer to an outer end of the nozzle hole in the radial direction than a midpoint between the outer end and an inner end of the nozzle hole in the radial direction.

3. The fuel nozzle for the gas turbine according to claim 1,
wherein, in the projection plane, each of the plurality of nozzle holes has a shape surrounded by:
a first circle;
a second circle having a center positioned on a radially outer side of the nozzle body than a center of the first circle, and having a larger diameter than the first circle; and
two common tangents of the first circle and the second circle.

4. The fuel nozzle for the gas turbine according to claim 1,
wherein each of the plurality of nozzle holes has a contour including a first linear contour portion and a second linear contour portion, in a cross-section orthogonal to the axial direction of the nozzle body, and
wherein, in the cross-section, the plurality of nozzle holes include a pair of nozzle holes adjacent to each other in the circumferential direction of the nozzle body such that the first linear contour portion of one nozzle hole of the pair of nozzle holes and the second linear contour portion of the other nozzle hole of the pair of nozzle holes are disposed adjacent to each other in the circumferential direction.

5. The fuel nozzle for the gas turbine according to claim 1,
wherein a position of the center axis of each of the plurality of nozzle holes at an upstream end of the nozzle hole and a position of the center axis at a downstream end of the nozzle hole are displaced from each other in the circumferential direction of the nozzle body.

6. The fuel nozzle for the gas turbine according to claim 1, further comprising a passage positioned on a radially outer side of the nozzle body than the plurality of nozzle holes and extending in the axial direction of the nozzle body,
wherein the passage has an air injection opening for injecting air to the downstream end portion in the axial direction of the nozzle body.

7. The fuel nozzle for the gas turbine according to claim 1,
wherein the fuel supply paths are configured to supply a gas fuel as the fuel to the plurality of nozzle holes, respectively.

8. The fuel nozzle for the gas turbine according to claim 1, further comprising a liquid fuel nozzle extending along the center axis of the nozzle body,
wherein the plurality of nozzle holes are positioned radially outside the liquid fuel nozzle.

9. A combustor for a gas turbine, comprising:
the fuel nozzle according to claim 1; and
a combustion tube forming a passage for a combustion gas generated by combustion of a fuel injected from the fuel nozzle.

10. A gas turbine, comprising:
the combustor according to claim 9; and
a stator vane and a rotor blade disposed downstream of the combustion tube for the combustor.
